(19) United States
(12) Patent Application Publication
(10) Pub. No.: US 2009/0025428 A1
(43) Pub. Date: Jan. 29, 2009

(54) METHOD AND DEVICE FOR HOMOGENIZING A GLASS MELT

(76) Inventors: Karin Naumann, Ober-Olm (DE); Christoph Berndhaeuser, Nieder-Olm (DE); Frank-Thomas Lentes, Bingen (DE); Holger Hunnius, Mainz (DE); Gregor Roesel, Ginsheim-Gustavsburg (DE); Franz Ott, Konnersreuth (DE); Markus Ollig, Weiden (DE); Sven Petri, Udenheim (DE)

Correspondence Address: Striker, Striker & Stenby, 103 East Neck Road, Huntington, NY, 11743, US

(21) Appl. No.: 12/174,705

(22) Filed: Jul. 17, 2008

(30) Foreign Application Priority Data
Jul. 25, 2007 (DE) 10 2007 035 203.6

(51) Int. Cl. C03B 5/18

(52) U.S. Cl. 65/135.3; 65/178

(57) ABSTRACT

The invention relates to a method and a device for homogenizing a glass melt using at least one stirring means which is respectively arranged in a stirring vessel having an inlet (4) and an outlet (5), the respective stirring means having a plurality of stirrer blades (11, 20, 21) arranged spaced apart from one another along a common stirrer shaft (10).

According to the invention, the stirring means and/or the device is configured in such a way that a net conveying effect of the stirring means overall from the inlet to the outlet is substantially imperceptible. The conveying effect of the stirring means overall from the inlet (4) to the outlet (5) is caused by the positioning of the stirring blades (11, 20, 21), by the geometric shape thereof and/or by the angular position of the stirring blades in the circumferential direction of the stirrer shaft (10).

According to the invention, the rotational speed of the stirring means can be freely varied at least within certain limits, in order to set a desired degree of homogenization of the glass melt, without this leading to a significant change in the total throughput of the device.

The present application claims the priority of German patent application No. 10 2007 035 203.6-45, filed on 25 Jul. 2007, “Method and Device for Homogenizing a Glass Melt”, the content of which is expressly included herewith by reference.

### FIELD OF THE INVENTION

The present invention relates to the homogenizing of a glass melt, in particular to the homogenizing of a glass melt used for producing a high-quality glass or glass ceramic product having a low density of inclusions and/or defects, for example display glass or glass tubes.

### BACKGROUND OF THE INVENTION

The aim of homogenizing a glass melt is to reduce, in accordance with the product requirements, spatial and temporal fluctuations in the chemical composition of the glass melt. The reason for this is that that chemical inhomogeneities lead to inhomogeneities of the refractive index, which can for example impair optical imaging, and to inhomogeneities of viscosity which in hot treatment processes can lead for example to uncontrolled fluctuations in geometry. In this case, a distinction is drawn between macroinhomogeneities, i.e. a variation of a chemical composition on comparatively large spatial scales, for example of a few centimeters, with small spatial gradients, and microinhomogeneities (also referred to as smears), i.e. a variation of chemical composition on small spatial scales, for example of from 0.1 to 2 mm, with in some cases large spatial gradients. The aim of the homogenization process is to eliminate macroinhomogeneities and microinhomogeneities as far as possible, thus allowing for example an even course of the refractive index to be obtained.

Glass melts are characterized in that they have in typically used stirring systems a viscosity of between about 1 and 200 Pa·s, causing a laminar flow of the glass melt (Reynolds number<1), and in that the chemical diffusion coefficient is normally less than 10⁻¹² m²/s, so that the homogenization which can be achieved by diffusion is negligibly small. Instead, homogenization in glass melts can be achieved substantially only as a result of local inhomogeneities or smears being markedly stretched, redistributed and chopped. For this purpose, use is made of stirring systems having a melt container for temporarily receiving the glass melt and also at least one stirring means for stirring the glass melt in the melt container.

In order to allow suitable homogenization to be achieved in the first place under the aforementioned conditions, in particular high viscosities and small chemical diffusion coefficients, the gap between stirrer blades of the stirring means and the wall of the melt container is conventionally kept as narrow as possible. However, an excessively narrow gap between the stirrer blades and the melt container wall harbors the risk that the stirrer will enter into contact with the vessel wall and the stirrer and/or the stirring vessel will as a result become damaged. As thermally induced deformations of the stirrer or the stirrer system occur at the conventional operating temperatures, the components become maladjusted over the course of the operating time. This can lead to an excessively small distance between the stirrer blades and the melt container wall and thus to direct material contact leading ultimately to the destruction of the stirring system.

Typically, the relative edge gap width, i.e. the ratio 0.5*(diameter of the stirring means or diameter of the melt container minus the diameter of the stirrer)/(diameter of the stirring means or of the melt container), is less than about 5% or even less than about 1% of the melt container diameter or diameter of the stirring means. Owing to the aforementioned thermal deformation of the components, the width of the gap cannot be reproducibly adhered to.

High shear stresses between the stirrer blade and melt container wall owing to an excessively narrow edge gap can significantly curtail the service life of the stirring system. There is also the risk that, in the event of an excessively narrow edge gap, bubbles, which adhere to the melt container wall, will become sheared off and enter the product. High shear stresses can eventually also cause abrasion of the wall material of the melt container or stirring vessel, and this can lead to microinclusions in glass or glass ceramic, which are undesirable especially in display glasses.

US 2003/0101750 A1 discloses a method and a device for homogenizing a glass melt for the production of display glass. In this case, a predetermined shear rate is selected at a predetermined stirring efficiency which is determined by the diameter of the stirrer, speed of the stirrer and edge gap. The edge gap is comparatively narrow and corresponds to a width of from about 6 to 9% of the free diameter of the stirring vessel.

For the aforementioned reasons, according to the prior art, a stirring gap which is as narrow as possible is sought in all cases in order to achieve as high homogeneity as possible.

Further homogenization can also be achieved as a result of the geometry of the stirrer blades themselves. It is preferable in this case to set the inclination of the stirrer blades, and thus the conveying effect of the stirrer, in such a way that these each operate counter to the glass stream in the glass melt container. In this case, an axial conveying effect can be achieved by positioning of the stirrer blades, by the geometric shape of the stirrer blades and/or a helical arrangement of the stirrer blades on the stirrer shaft. JP 63008226 A discloses for example that the inclination of the stirrer blades, and thus the conveying effect of the stirrer, is set in such a way that these each operate counter to the glass stream. This is intended to prevent dead spaces in the glass melt container.

JP 10265226 A discloses a device for homogenizing a glass melt, comprising a stirring means having inner stirrer blades which generate in a stirring vessel a downwardly directed flow of the glass melt and outer stirrer blades which generate in the stirring vessel an upwardly directed flow of the glass melt. Overall, there is thus formed in the stirring vessel a substantially closed flow roll which sweeps the entire height of the stirring means in the axial direction of the stirrer shaft. The flow roll is directed upward in the edge gap between the inner wall of the stirring vessel and the leading ends of the stirring blades and directed downward in the inner stirring region, i.e. in the inner region of the stirring vessel in proximity to the center of rotation of the stirring means. The inlet is located in proximity to the lower end of the stirring vessel and the outlet in proximity to the upper end of the stirring vessel. Thus, the flow roll in the edge gap entrains the inflowing glass melt upward, where inhomogeneities are initially transported into the inner stirrer region in proximity to the center of rotation of the stirring means. Only after at least one circulation can the glass melt issue from the stirring vessel again. However, the stirring means itself exerts a certain net conveying effect, so that a change in the degree of homogenization invariably also has an influence on the throughput of the device.

Co-pending U.S. patent application by the Applicant “Method and Device for Homogenizing a Glass Melt”, Ser. No. 11/957,727, filed on 17 Dec. 2007, claiming the priority of German patent application No. 10 2006 060 972.7 of the Applicant, filed on 20 Dec. 2006, entitled “Method and Device for Homogenizing a Glass Melt”, discloses a device for homogenizing a glass melt which will be described hereinafter in greater detail with reference to FIGS. 1 to 2b. According to FIG. 1, a stirrer having a plurality of stirring blades 11 is arranged in a point-symmetrical arrangement in an overall cylindrical stirring vessel 2. All of the stirrer blades 11 convey the glass melt 3 in the same direction, i.e. directed axially downward in FIG. 1. As is indicated by arrow 12, there is exerted in the inner stirring region between the stirring shaft 10 and the leading ends of the stirrer blades 11 an axial conveying effect which conveys the entering glass melt 3 from the upper axial end of the inner stirring region 12 toward the lower axial end thereof. An upwardly directed counterflow is therefore induced in the edge gap 16, as indicated by the arrow, as a result of which the passage of smears or inhomogeneities through the edge gap 16 is downwardly blocked and the edge gap is dynamically sealed.

Thus, the smears or inhomogeneities in the glass melt 3 are drawn into the inner stirring region 12 where they are stirred up, thus causing homogenization of the glass melt.

In the case of this device, there is however a certain axial conveying effect in the direction of the general glass flow from the inlet 4 and toward the outlet 5, so that a change in the degree of homogenization resulting from variation of the rotational speed of the stirring means invariably also causes a change in the total throughput of the device.

### SUMMARY OF THE INVENTION

Despite the manifold efforts made in the prior art, there is still a need for methods and devices allowing even more efficient homogenization of glass melts. In particular, the present invention is intended to provide a method and a device for homogenizing a glass melt, allowing a predetermined degree of homogenization to be set, without thereby significantly influencing the drop in pressure in the system and/or the total throughput. In particular, a method of this type and a device of this type are intended also to allow low loading of the components of the device with simple and precise adjustment of the device and as low abrasion as possible or a low shearing-off rate of bubbles.

The invention thus starts from a method for homogenizing a glass melt using at least one stirring means which is respectively arranged in a stirring vessel having an inlet and an outlet, the respective stirring means having a plurality of stirrer blades arranged spaced apart from one another along a common stirrer shaft, and at least two stirrer blades being positioned opposite one another.

According to the invention, the stirring means and/or the device are configured in such a way that a conveying effect or net conveying effect of the stirring means overall from the inlet to the outlet is substantially imperceptible. Thus, according to the invention, the rotational speed of the stirring means can be freely varied within certain limits, in order to set a desired degree of homogenization of the glass melt, without this leading to a significant change in the total throughput of the device. In this case, the aforementioned rotational speed range corresponds to the range of conventional rotational speeds of the stirring means, which for example can reach from about 10 to about 100 rpm. Outside this rotational speed range, it is entirely possible for a certain drop in pressure or a certain net conveying effect to exist. Most particularly preferably, the net conveying effect of the stirring means is almost imperceptible even outside the predetermined rotational speed range. The glass melt is thus conveyed by the homogenizing device owing to a different drive force, in particular owing to a prevailing hydrostatic pressure or else owing to a preceding and/or subsequent conveying means.

In this case, the stirrer blades protrude substantially radially from the stirrer shaft and are preferably formed as flat, planar structures which are disposed such as to form an angle of attack, i.e. which enclose an acute angle with a plane perpendicularly intersecting the stirrer shaft. This angle can for example be in the range of from about −89° to 0° or 0° to 89°, a change in sign denoting reversal of the direction of the conveying effect.

Obviously, the stirrer blades can also have curved surfaces, in which case the angle of transition for changing the direction of conveyance may also differ.

In this case, the overall substantially imperceptible net conveying effect of the device is achieved as a result of the fact that the stirrer blades along the stirrer shaft generate at least two zones which are spaced apart from one another along the stirrer shaft and have an opposing conveying effect. The conveying effects of these zones which are spaced apart from one another substantially cancel one another out, so that the device does not impose any further conveying effect on the externally imposed glass melt stream.

According to a further embodiment, the conveying effect of the stirring means overall from the inlet to the outlet is less than ±5% based on the total melt flow, in particular within the aforementioned rotational speed range of the stirring means. Overall, the thus remaining conveying effect is also negligible, so that the rotational speed range of the stirring means can be freely varied to achieve a predetermined degree of homogenization.

According to a further embodiment, the conveying effect of the stirring means is less than ±1%, based on the total melt flow from the inlet to the outlet, in particular within the aforementioned rotational speed range of the stirring means. Overall, the thus remaining conveying effect is also negligible, so that the rotational speed range of the stirring means can be freely varied to achieve a predetermined degree of homogenization.

According to a further embodiment, the conveying effect of the stirring means is caused overall by the angle of attack of the stirrer blades, by the geometric shape of the stirrer blades and/or by the angular position of the stirrer blades in the circumferential direction of the stirrer shaft (helical arrangement of all of the stirrer blades along the stirrer shaft). By varying these parameters, such as can be simulated in particular by numerical simulation, the achievable homogenization can be variably defined in the prescribed rotational speed range of the stirring means, although no further conveying effect is imposed on the externally generated glass melt flow.

In this case, the stirrer blades can be arranged at differing angular positions, so that overall a helical arrangement of the stirrer blades along the stirrer shaft is formed. The direction of rotation of this helix can be the same as or opposite to the direction of the externally imposed total melt flow. Overall, this helical arrangement of the stirrer blades prevents a direct throughflow of the glass melt through the inner stirrer region which is swept by the stirrer blades. In other words, the arrangement of the stirrer blades offset from a helical arrangement can overall block a direct path from the inlet toward the outlet. This prevents short-circuit flows of melting material subjected to little stirring.

In addition, the helical arrangement of the stirrer blades also leads to a conveying effect which, depending on the orientation, is active in the same direction as or the opposite direction to the imposed melt stream. In combination with the conveying effect of the blades themselves, this effect can be used to neutralize the net conveying effect.

According to a further embodiment, one or more stirrer blades is or are positioned in the region of the inlet in such a way that in a first zone a conveying effect is formed along the stirrer shaft and in a direction from the inlet toward the outlet. The achievable conveying effect in this first zone can in this case be adjusted by the shape and/or the angle of attack of the stirrer blade or stirrer blades.

According to a further embodiment, at least one stirrer blade is disposed in the region of the outlet having an axial conveying effect along the stirrer shaft and in a direction from the inlet and toward the outlet, wherein the conveying effect can also be adjusted by the shape and/or the angle of attack of the stirrer blades.

Arranged between these two regions is, according to a further embodiment, at least one stirrer blade forming a zone having an opposing conveying effect. The conveying effects in the various zones compensate for one another overall, so that the stirring means exerts overall no net conveying effect. This can be caused by suitable shaping of the stirrer blades and/or angular position of the stirrer blades and/or by a suitable angle of attack of the stirrer blades.

According to a further preferred embodiment, the stirrer blades exert overall both an axial and a radial conveying effect. The radial melt stream merges outside the inner stirrer region, i.e. in the gap between the inner wall of the stirring vessel and the leading ends of the stirrer blades, with an opposing glass melt flow within the inner stirrer region. In this way, the stirring means forms overall at least two roll-like flow regions, the conveying effects of which from the inlet toward the outlet overall compensate for one another to form an almost imperceptible net conveying effect of the stirring means. This applies also if more than two roll-like flow regions of this type are formed.

According to a further embodiment, the stirrer blades are overall configured in such a way that a melt stream caused overall by the conveying effect seals a gap between an inner wall of each stirring vessel and the stirrer blades from being directly flowed through by the glass melt. It has surprisingly been found that such dynamic sealing of the edge gap allows, despite much greater edge gap widths, outstanding homogenization of glass melts, in particular of highly viscous glass melts. Thus, according to the present invention, much greater edge gap widths can be used than was conventionally possible. According to the invention, the much greater edge gap widths allow loading of the components of the device to be significantly reduced. In particular, the invention allows negligible abrasion of material and also a low shear off-rate of bubbles to be achieved while at the same time keeping the costs for adjusting the components of the device advantageously low.

In this way, it is in particular achieved that according to the invention all glass inhomogeneities, irrespective of the location at which they enter the stirring system, pass into the inner stirring region between the stirrer shaft and the ends of the stirrer blades, where they are reduced by stretching, chopping and spatial redistribution. In this case, the method according to the invention allows comparatively high gap widths to be achieved between the stirrer blades and the inner wall of the stirring vessel. In this way, disruptive effects caused by high shear rates, such as for example abrasion, corrosion or inclusions owing to abrasion of lining material of the stirring vessel and/or stirrer blade material, can be prevented.

The aforementioned active sealing of the edge gap is, according to a further embodiment, achieved in particular by the formation of alternating zones which have an opposing conveying effect within the edge gap and prevent direct passage of the glass melt flowing in through the inlet through the gap toward the outlet.

According to a further embodiment, the stirrer blades of the stirring means extend over a portion of the cross section of the inlet of the melt container. Thus, a certain portion of the cross section of the melt flow flowing in through the inlet is covered by the stirrer blades to prevent direct entry of the inflowing glass melt into the inner stirring region. Instead, the inflowing glass melt is diverted, irrespective of the location at which it enters, toward the upper end of the stirring means, in order only there to pass into the inner stirring region. The percentage by which the cross section of the inflowing glass melt is covered by the stirrer blades can be greater than 0% and be up to 50%. Unlike in the prior art, the stirrer blades thus protrude beyond the lower edge of the inlet.

According to a further embodiment, the stirring vessel is oriented in the vertical direction, i.e. in the direction of gravity, the inlet being provided at the upper end of the stirring vessel and the outlet at the base of the stirring vessel and the pressure driving the total melt flow being caused substantially by a hydrostatic pressure, leading to a particularly advantageously uniform glass melt flow. The glass melt can in this case flow continuously through the device. According to a further embodiment, the melt container can also be flowed through discontinuously; this can be achieved for example by intermittent replenishment. Overall, the glass melt flows through the device in this case respectively in a predetermined throughput direction.

Preferably, the stirring vessel is formed as a cylinder wherein the stirring means is arranged concentrically. In this case, the lower end of the stirring vessel surrounds the lower end of the stirring means. The lower outlet of the stirring vessel can in this case taper conically or be formed in a planar, flat base. Preferably, the outlet of the stirring vessel is arranged concentrically. In principle, however, eccentric arrangements of the outlet are also conceivable.

The aforementioned parameters, in particular the angle of attack of the stirrer blades, the geometric shape of the stirrer blades, the helical arrangement of the stirrer blades along the circumference of the stirrer shaft, the selection of the rotational speed of the stirrer, of the diameter of the stirring means, of the number of stirrer blades, the conveying effect of the stirrer blades and the like, can in particular be simulated and obtained with the aid of a mathematical and/or physical simulation of the flow conditions in the glass melt container, so that based on such simulation, an optimum degree of homogenization can be achieved depending on the required specifications. For physical simulation, use may in particular be made of model systems having comparatively scaled-down dimensions and viscosities, wherein the homogenization can be visually examined and optically evaluated by introducing color strips into the inflowing, suitable viscous liquid.

A plurality of stirring vessels can in this case be successively connected in a suitable manner in series or in parallel. In this case, stirring vessels connected in immediate succession can be arranged at the same level, the outlet of an upstream stirring vessel being connected to the inlet of a downstream stirring vessel via an obliquely rising line or tube. Alternatively, stirring vessels connected in immediate succession can also be arranged at differing levels, in which case the connecting line or tube between the outlet of an upstream stirring vessel and the inlet of a downstream stirring vessel can also run horizontally. In both cases, the total melt flow is driven preferably owing to a hydrostatic pressure in the device as a whole.

According to a preferred embodiment, the width of the edge gap between the leading ends of the stirrer blades and the inner surface of the stirring vessel corresponds to more than 3% to 13%, more preferably more than 5% to 10%, of the diameter of the stirring vessel. Thus, according to the invention, the edge gap can be comparatively wide and according to the invention undesirable disruptive effects, such as for example abrasion or corrosion of material of the walls of the stirring vessel and/or the stirring means, can be avoided.

A preferred use of the method according to the invention or of the device according to the invention relates to the homogenizing of a glass melt in the production of display glass, a glass ceramic, of borosilicate glasses, optical glasses or a glass tube. Preferably, the device is in this case arranged directly before a glass feeder for issuing the homogenized glass melt. In this case, an intermediate buffer for the glass melt does not have to be provided between the device and the glass feeder. Instead, the device and the glass feeder can be directly connected to each other via a tube-like connecting line, which may even have a larger diameter than the diameter of the stirring vessel. The glass feeder can be a nozzle for issuing the glass melt, also in the form of a nozzle shaping the glass melt, a glass feeder for issuing the glass melt onto a hot tin melt within the production float glass, in particular for LCD displays, a nozzle for issuing the hot glass melt onto the outer circumference of a Danner pipe within the production of glass tubes or an annular gap for issuing the glass melt within a conventional Vello method for the production of glass tubes.

### OVERVIEW OF THE DRAWINGS

The invention will be described hereinafter in greater detail by way of example and with reference to the appended drawings from which further features, advantages and objects to be achieved will become apparent. In the drawings:

FIG. 1 is a schematic sectional view of a device according to the prior art;

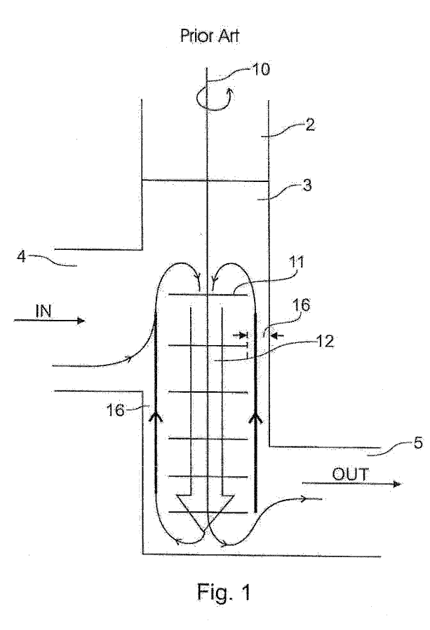

FIG. 2a shows a conventional stirring means;

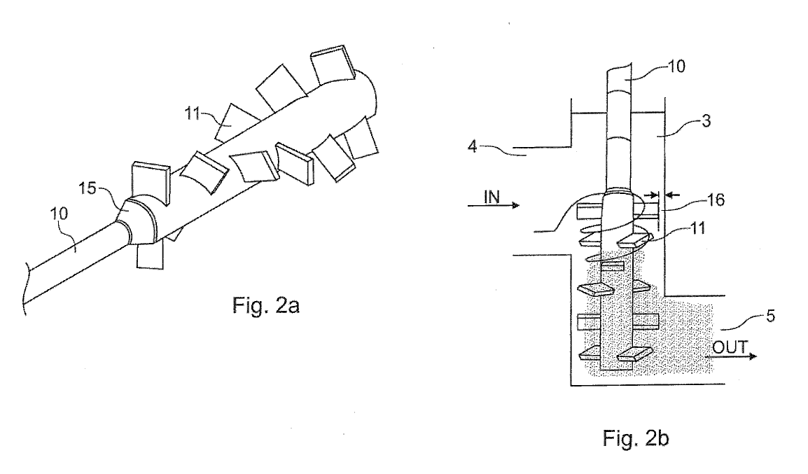

FIG. 2b shows the arrangement of the stirring means according to FIG. 2a in a stirring vessel according to FIG. 1;

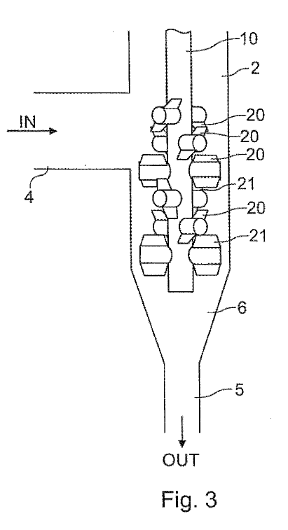

FIG. 3 is a schematic sectional view of a device according to a first embodiment of the present invention;

FIG. 4 illustrates schematically the conveying effect of the stirrer blades of the stirring means according to FIG. 3;

FIG. 5 is a schematic sectional view of a device according to a further embodiment of the present invention;

FIGS. 6a to 6c show the specific configuration of the stirrer blades of a device according to the invention;

FIGS. 7a and 7b show the specific design of the stirrer blades according to further embodiments of the present invention;

FIG. 8 shows the net conveying effect of the device according to the invention compared to an ideal, non-conveying stirrer and also with conventional stirring devices; and

FIG. 9 shows the arrangement of the stirring device according to FIG. 3 directly before a glass feeder for issuing the homogenized glass melt onto the outer circumference of a rotating Danner pipe within the production of glass tubes.

In the figures, identical reference numerals denote identical or substantially equivalent elements or groups of elements.

### DETAILED DESCRIPTION OF PREFERRED EXEMPLARY EMBODIMENTS

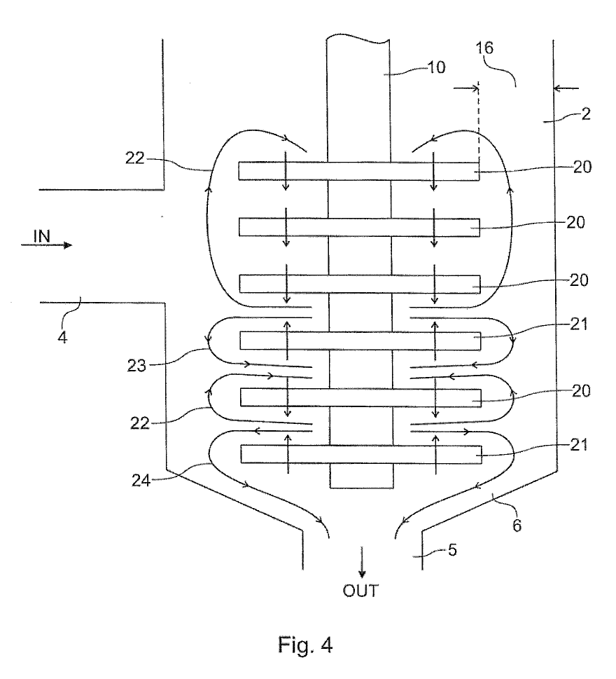

According to FIG. 3, a stirrer having a plurality of stirrer blades 20, 21 is arranged in a point-symmetrical arrangement in an overall cylindrical stirring vessel 2. A glass melt is received in the stirring vessel 2. The glass melt can flow through the stirring vessel 2 continuously or discontinuously, from the inlet 4 and toward the outlet 5. The overall conveying effect of the stirrer is according to the invention imperceptible or substantially imperceptible, so that the total melt flow through the stirring device is externally driven, in particular by applying a hydrostatic pressure. For this purpose, the stirring vessel 2 can be arranged so as to extend in the direction of gravity. According to FIG. 3, the inlet 4 is arranged at the upper end of the stirrer and the outlet 5, which is equipped with a conically tapering base 6, at the lower end of the stirrer.

According to FIG. 3, the top three stirring blades 20 cover the bulk of the inlet 4. Preferably, the stirrer covers at least 50% of the cross section of the inlet 4 and even more preferably at least two thirds of the cross section of the inlet 4. In FIG. 3, the stirrer blades which owing to the angle of attack exert a downwardly directed conveying effect are denoted by reference numeral 20 and those stirrer blades which owing to the angle of attack exert an upwardly directed conveying effect are denoted by reference numeral 21.

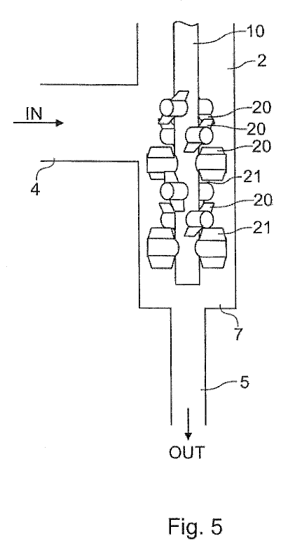

FIG. 4 is a schematic illustration of the flow conditions in the stirring vessel 2 for the stirrer according to FIG. 3. In this illustration, for the sake of simplicity, the stirrer blades 20, 21 are illustrated merely schematically as rectangles and the conveying effect respectively exerted by the stirrers is indicated by an upwardly or downwardly directed arrow. According to FIG. 4, the top three stirrer blades 20 exert a downwardly directed conveying effect, the adjoining stirrer blade 21 exerts an upwardly directed conveying effect, the adjoining stirrer blade 20 exerts a downwardly directed conveying effect and the bottom stirrer blade 21 exerts an upwardly directed conveying effect. The downwardly and upwardly directed arrows in FIG. 4 indicate the conveying effect within the inner stirring region, i.e. in the region of the rotating stirrer blades 20, 21. In the edge gap between the stirrer blades 20, 21 and the inner wall of the stirring vessel 2, an opposing flow must build up for reasons of conservation of mass and continuity of the flow. Said opposing flow is directed upward in the edge gap in the region of the top three stirrer blades 20, as indicated by reference numeral 22, is directed downward in the edge gap in the region of the adjoining stirrer blade 21, as indicated by reference numeral 23, is directed upward in the edge gap in the region of the adjoining stirrer blade 20, as indicated by reference numeral 22, and is again directed downward in the region of the outlet or bottom stirrer blade 21, as indicated by reference numeral 24. The arrows associated with reference numerals 22 to 24 each indicate the direction of flow within the edge gap 16.

Owing to the flow 22 directed upward in the edge gap 16, the glass melt flowing in through the inlet 4 is entrained upward in order to pass at the upper end of the stirrer into the inner stirring region, with the axially downwardly directed conveying effect prevailing therein. The upwardly directed flow 22, substantially completely covering the cross section of the inlet 4, prevents direct passage of the glass melt flowing in through the inlet 4 through the edge gap 16 toward the outlet 5. The opposing flow roll 23 and the opposing conveying effect of the adjoining stirrer blade 21 prevent direct passage of the axially downwardly conveyed glass melt to the outlet 5. Instead, there is substantial swirling of the glass melt in the region of transition between the flow rolls 22 and 23, causing homogenization of the glass melt. Corresponding homogenization is also caused in the region of transition between the flow rolls 23 and 22 in the region of transition between the (viewed from above) fourth and fifth stirrer blades 21, 20, and also in the region of transition between the (viewed from above) fifth and sixth stirrer blades 20, 21, i.e. in the region of transition between the flow rolls 22 and 24.

The conveying effect, which in the edge gap is directed upward and downward in alternation, of the flow rolls 22 to 24 also prevents direct passage of the glass melt through the edge gap 16 toward the outlet 5. The opposing conveying effect, which alternates in the inner stirring region, of the stirrer blades 20, 21 also prevents direct axial passage of the glass melt in the inner stirring region toward the outlet 5.

The flow conditions in the stirring vessel 2 can be precisely defined by the geometric shape of the stirrer blades 20, 21, by the angle of attack thereof and/or by the angular positions of the stirrer blades 20, 21 in the circumferential direction of the stirrer shaft 10. According to the invention, the stirrer blades 20, 21 are configured in such a way that the overall conveying effect of the stirring means is overall imperceptible or almost imperceptible, at least within the prescribed rotational speed range of the stirring means, which can for example be in the range of between about 10 rpm and 100 rpm. Thus, the total melt flow is not changed at all or is substantially not changed by the stirring vessel 2 in the event of a varying rotational speed of the stirring means. Thus, suitable setting of the rotational speed of the stirrer allows the achievable degree of homogenization to be adjusted almost as desired, without thereby significantly influencing the throughput or the total melt flow through the stirring vessel 2. Instead, this is caused by external application of a hydrostatic pressure or by means of an external conveying means.

According to a further embodiment, the stirrer blades 20, 21 can overall be configured in such a way that at least within the prescribed rotational speed range of the stirring means, i.e. in particular in the range of between about 10 rpm and 100 rpm, the throughput or total melt flow through the stirring vessel 2 is varied, if the rotational speed varies within certain limits, slightly, for example up to at most ±5%, more preferably up to at most ±1%, based on the total throughput or total melt flow through the stirring vessel 2. In this alternative embodiment, a change in rotational speed thus results in a slight change in the total throughput or total melt flow through the stirring vessel 2, allowing in certain applications a certain regulation of the total throughput by adjustment of the rotational speed of the stirring means.

As is immediately apparent from FIG. 4, the stirrer blades 20, 21 cause overall an axial and radial conveying effect. In the inner stirring region and also in the edge gap 16, alternating zones 22, 23, 24 having an opposing conveying effect are according to the invention formed along the stirrer shaft 10.

As may be derived from FIG. 3, this conveying effect is brought about in particular by the angle of attack of the stirrer blades 20, 21. If the stirrer blades 20, 21 are flat, planar, blade-like structures, the exerted conveying effect changes, on exceeding an angle of attack of 45°, from a flow directed axially downward to a flow directed axially upward. This region of transition can also be at a different angle in the event of a different configuration of the stirrer blades 20, 21 and/or arrangement thereof.

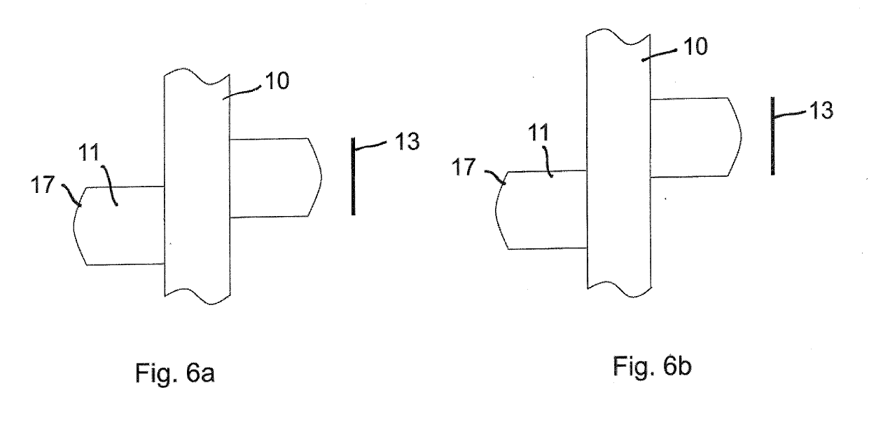

FIG. 5 shows a further embodiment of a device in which the base 7 of the stirring vessel 2 is planar in its configuration. Both in the embodiment according to FIG. 3 and in that according to FIG. 5, the outlet 5 can be arranged concentrically with or eccentrically to the stirring vessel 2.

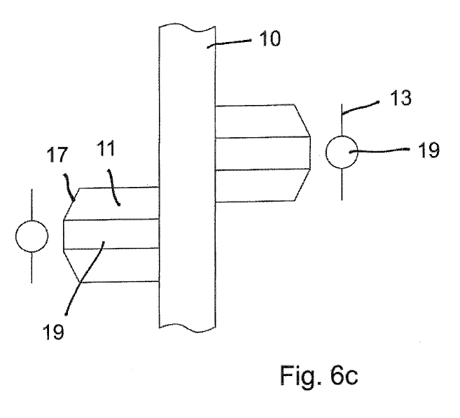

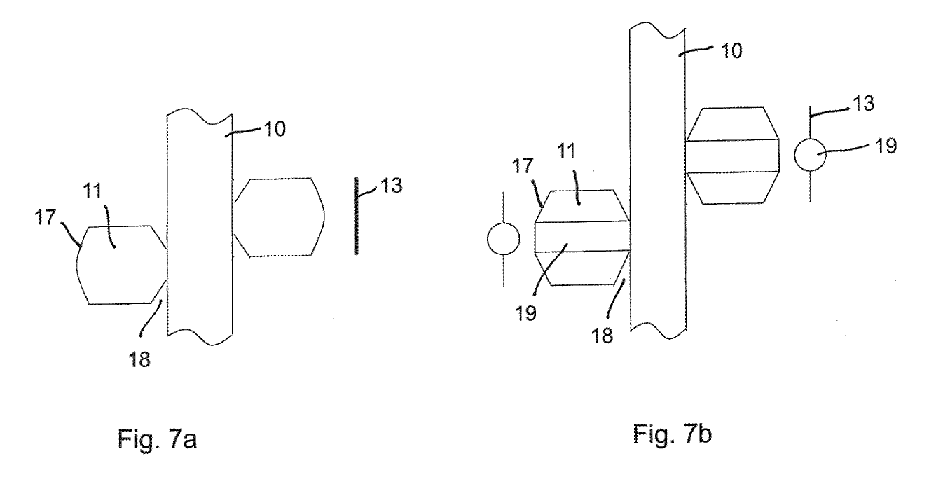

Further possible configurations for influencing the exerted conveying effect will be described hereinafter with reference to FIGS. 6a to 7b. According to FIG. 6a, the trailing ends of the stirrer blades 11 directly abut the outer circumference of the stirrer shaft 10 and the leading edge 17 of the stirrer blade 11 is beveled in its formation. As indicated by the vertical bar 13 in the right-hand part of the diagram of FIG. 6a, the stirrer blade 11 is flat, i.e. formed as a plate-like element. According to FIG. 6a, the stirrer blades 11, which are vertically offset from one another, overlap slightly. According to FIG. 6b, the stirrer blades 11 are arranged offset from one another by precisely the height of one stirrer blade 11.

FIG. 6c shows a further embodiment in which the stirrer blades 11 protrude radially from a cylindrical projection 19 which, for its part, protrudes radially from the stirrer shaft 10. The trailing ends of the stirrer blades 11 directly adjoin the outer circumference of the stirrer shaft 10, whereas the leading edges 17 are beveled in their formation. The left and right-hand parts of the diagram of FIG. 6c are a plan view onto the end face of the stirrer blades 11. The end face 13 of the stirrer blades 11 is flat; the circular cross section of the cylindrical projections 19 may also be seen.

The beveled portion at the leading end 17 of the stirrer blades 11 prevents excessive stresses at the corner regions of the stirrer blades 11.

FIGS. 7a and 7b show preferred stirring blade geometries to improve the degree of homogenization. According to FIG. 7a, a beveled portion 18 is additionally provided also at the trailing end of the stirrer blades 11. According to FIG. 7b, such beveling 18 can be provided also in embodiments in which the stirrer blades 11 protrude radially from a cylindrical projection 19 which, for its part, protrudes radially from the stirrer shaft 10.

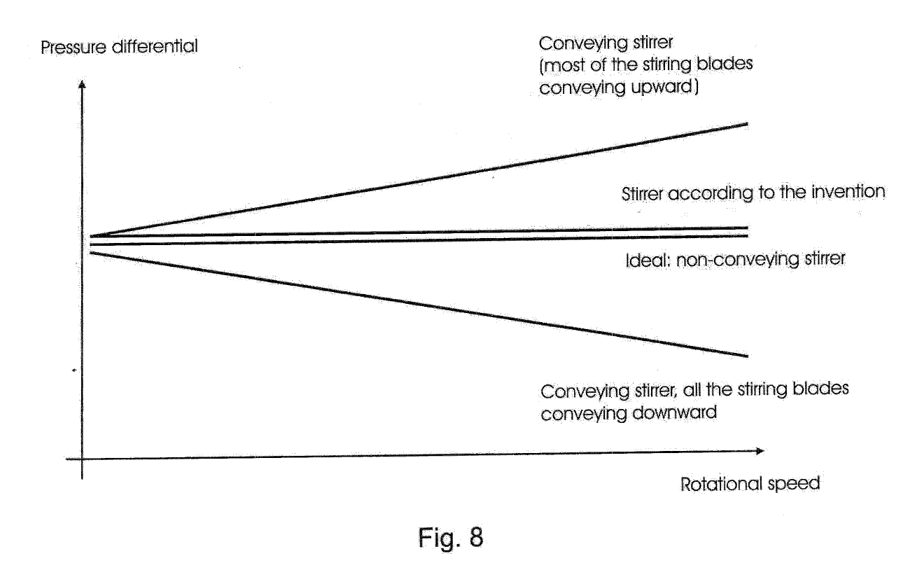

FIG. 8 shows schematically the conveying effect exerted by the stirrer according to the invention as a function of rotational speed. The rotational speed range according to FIG. 8 can for example reach from 0 rpm to about 100 rpm, although this is not intended to limit the invention. The horizontal curve corresponds to the behavior of an ideal, non-conveying stirrer which causes a constant pressure differential. Compared thereto, the stirrer according to the invention leads to a slightly higher pressure differential which is however also substantially constant over the entire prescribed rotational speed range. Compared thereto, the exerted pressure differential increases in the upper curve for a conveying stirrer in which most of the stirring blades convey upward, as rotational speed increases, whereas according to the lower curve for a conveying stirrer, in which all of the stirring blades convey downward, the pressure differential drops as rotational speed increases. In other words, for the conventional conveying stirrers according to the upper and lower curve, as rotational speed increases, an increasing or decreasing conveying effect is caused, so that a change in the degree of homogenization by changing the rotational speed automatically leads to a change in throughput or in the total melt flow through the stirring vessel 2. In contrast thereto, in the case of the stirrer according to the invention (2^{nd} curve from the top), the rotational speed can be freely varied for precisely adjusting a desired degree of homogenization, in any case within the prescribed rotational speed range, without this leading to a significant change in throughput or total melt flow.

It should expressly be mentioned that the curves according to FIG. 8 are based on experimental values (not shown) which were measured by physical simulation in comparable systems with comparatively viscous liquids and at a comparable Reynolds number.

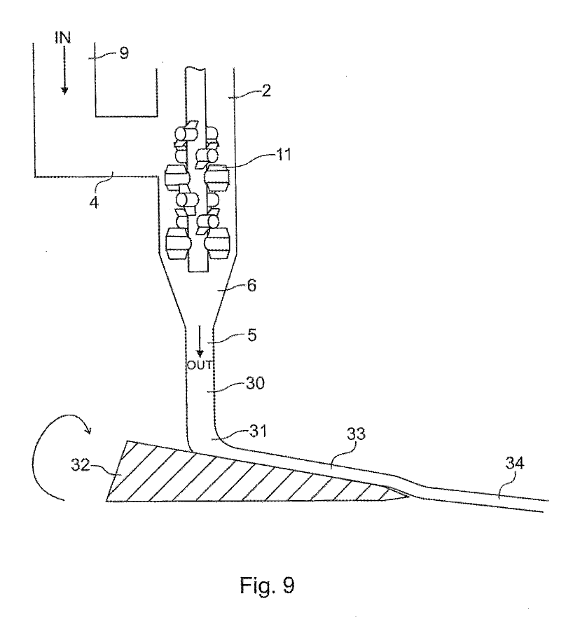

FIG. 9 shows as an example of a preferred use the arrangement of a stirring means according to the invention directly before a glass feeder 30 from which the issuing glass melt 31 issues onto the outer circumference of a rotating Danner pipe 32 in order to form at this location a closed glass melt casing 33 leading, after removal (directed toward the right in FIG. 9), to a glass tube having a substantially constant outer diameter and a constant wall thickness. According to FIG. 9, the glass feeder 30 is arranged directly after the outlet 5, i.e. without the interposition of intermediate buffers. This presupposes a highly constant throughput of the stirring vessel 2 which according to the invention can be achieved owing to the angle of attack, the geometric shape and/or the angular positions of the stirrer blades in the circumferential direction of the stirrer shaft. As shown in FIG. 9, the glass melt enters the inlet 4 through a vertically upwardly extending connecting leg 9, so that overall an external hydrostatic pressure acts on the stirring vessel 2 to drive the glass melt toward the outlet 5.

As will be immediately apparent to a person skilled in the art, the underlying principle of the present invention can be used for homogenizing a glass melt in the production of display glass, in particular panes of glass for LCD, OLED or plasma displays, for the production of glass ceramics, of borosilicate glasses, of optical glasses or of glasses within the production of glass tubing. The dynamic sealing of the edge gap allows much higher gap widths to be achieved, so that the abrasion of materials according to the invention can be reduced. This also leads to particles, which according to the prior art are removed and impair the quality of the glass, no longer occurring in accordance with the invention.

What is claimed is:

1. A method for homogenizing a glass melt using at least one stirring means which is respectively arranged in a stirring vessel having an inlet and an outlet, the respective stirring means having a plurality of stirrer blades arranged spaced apart from one another along a common stirrer shaft, in which method
a conveying effect of the stirring means overall from the inlet to the outlet is substantially imperceptible.

2. The method as claimed in claim 1, wherein the conveying effect of the stirring means overall from the inlet to the outlet is less than ±5%, more preferably less than ±1% based on the total melt flow from the inlet to the outlet.

3. The method as claimed in claim 1, wherein at least two stirrer blades are arranged at an opposite angle of attack, so that the stirrer blades generate at least two zones which are spaced apart from one another along the stirrer shaft and have an opposing conveying effect.

4. The method as claimed in claim 3, wherein the conveying effect of the stirring means overall from the inlet to the outlet is caused by at least one of the positioning of the stirring blades, the geometric shape of the stirrer blades and the angular position of the stirrer blades in the circumferential direction of the stirrer shaft.

5. The method as claimed in claim 3, wherein
at least one stirrer blade in the region of the inlet and/or at least one stirrer blade in the region of the outlet each form a zone having an axial conveying effect along the stirrer shaft and in a direction from the inlet and toward the outlet and wherein
spaced apart from this zone or between these zones at least a second zone having an opposing conveying effect is formed.

6. The method as claimed in claim 1, wherein the stirrer blades cause an axial and radial conveying effect.

7. The method as claimed in claim 1, wherein a melt stream caused overall by the conveying effect seals a gap between an inner wall of each stirring vessel and the stirrer blades from being directly flowed through by the glass melt.

8. The method as claimed in claim 7, wherein there are formed in the gap alternating zones which have an opposing conveying effect and prevent direct passage of the glass melt flowing in through the inlet through the gap toward the outlet.

9. The method as claimed in claim 1, wherein front stirrer blades, viewed in the direction of flow, extend in the region of the inlet over a portion of the cross section of the inlet.

10. The method as claimed in claim 9, wherein the front stirrer blades in the direction of flow cover more than 0% and up to 50% of the cross section of the inlet.

11. The method as claimed in claim 1, wherein
the stirring vessel is oriented in the vertical direction,
the inlet is disposed at the upper end of the stirring vessel,
the outlet is disposed at the base of the stirring vessel and
the outlet is provided centrally at the base of the stirring vessel.

12. The method as claimed in claim 11, wherein the base of the stirring vessel is conically tapered or planar in its configuration.

13. The method as claimed in claim 1, wherein the glass melt being homogenized is used in the production of at least one of display glass, a glass ceramic, borosilicate glasses, optical glasses and a glass tube.

14. The method as claimed in claim 13, wherein the outlet is arranged directly before a glass feeder for issuing the glass melt.

15. The method as claimed in claim 14, wherein the glass feeder is part of a device for producing a glass tube or forms a glass forming means.

16. A device for homogenizing a glass melt, comprising at least one stirring means which is respectively arranged in a stirring vessel having an inlet and an outlet, the respective stirring means having a plurality of stirrer blades which are arranged spaced apart from one another along a common stirrer shaft, in which device
conditioned by at least one of the geometry of the stirring blade, the angle of attack of the stirring blades and the arrangement of the stirring blades along the stirrer shaft, a conveying effect of the stirring means overall from the inlet to the outlet is substantially imperceptible.

17. The device as claimed in 16, wherein the stirrer blades are configured in such a way that the conveying effect of the stirring means overall from the inlet to the outlet is less than ±5%, preferably less than ±1% based on the total melt flow from the inlet to the outlet.

18. The device as claimed in 16, wherein at least two stirrer blades are arranged at an opposite angle of attack with respect to each other, so that the stirrer blades generate zones which are spaced apart from one another along the stirrer shaft and have an opposing conveying effect.

19. The device as claimed in claim 16, wherein
the stirrer blades are configured in such a way that at least one stirrer blade in the region of the inlet and at least one stirrer blade in the region of the outlet each form a zone having an axial conveying effect along the stirrer shaft and in a direction from the inlet and toward the outlet and wherein
spaced apart from this zone or between these zones at least a second zone having an opposing conveying effect is formed.

20. The device as claimed in claim 16, wherein the stirrer blades are configured in such a way that a melt stream caused overall by the conveying effect seals a gap between an inner wall of each stirring vessel and the stirrer blades from being directly flowed through by the glass melt.

21. The device as claimed in 20, wherein the stirrer blades are configured in such a way that there are formed in the gap alternating zones which have an opposing conveying effect and prevent direct passage of the glass melt flowing in through the inlet through the gap toward the outlet.

22. The device as claimed in claim 16, wherein front stirrer blades, viewed in the direction of flow, extend in the region of the inlet over a portion of the cross section of the inlet and wherein
the front stirrer blades in the direction of flow cover more than 0% and up to 50% of the cross section of the inlet.

23. The device as claimed in 16, wherein a width of the gap is greater than 3% to 13% of the diameter of each stirring vessel.
